(19) United States
(12) Patent Application Publication
(10) Pub. No.: US 2026/0213413 A1
(43) Pub. Date: Jul. 23, 2026

(54) ANTENNA DEVICE

(71) Applicant: NGK INSULATORS, LTD., Nagoya-shi (JP)

(72) Inventors: Kentaro TANI, Nagoya-shi (JP); Jungo KONDO, Nagoya-shi (JP); Naotake OKADA, Nagoya-shi (JP); Masato NIWA, Nagoya-shi (JP); Shoichiro YAMAGUCHI, Nagoya-shi (JP)

(21) Appl. No.: 19/571,088

(22) Filed: Mar. 18, 2026

Related U.S. Application Data
(63) Continuation of application No. PCT/JP2023/033878, filed on Sep. 19, 2023.

(51) Int. Cl. H01Q 9/04

(52) U.S. Cl. CPC H01Q 9/0407

(57) ABSTRACT

An antenna device includes an inorganic material substrate, a first conductor layer, a supporting substrate, a cavity portion, and a ground conductor layer. The first conductor layer is arranged on one side of the inorganic material substrate in a thickness direction, and includes a patch antenna. The supporting substrate and the cavity portion are arranged on an opposite side to the first conductor layer with respect to the inorganic material substrate. The cavity portion is arranged on the inorganic material substrate side of the supporting substrate. The ground conductor layer is arranged in the cavity portion. A thickness “t” of the inorganic material substrate satisfies the below-indicated expression (1). When the patch antenna is projected in the thickness direction, at least a part of a projection surface of the patch antenna overlaps with the cavity portion.

$$t < \frac{λ}{a \sqrt{ε}} \qquad ( 1 )$$

### CROSS-REFERENCE TO RELATED APPLICATIONS

This application is a continuation under 35 U.S.C. 120 of International Application PCT/JP2023/033878 having the International Filing Date of Sep. 19, 2023. The identified application is fully incorporated herein by reference.

### BACKGROUND OF THE INVENTION

### 1. Field of the Invention

The present disclosure relates to an antenna device.

### 2. Description of the Related Art

Hitherto, there has been known an electromagnetic wave sensor which transmits an electromagnetic wave to an object to be detected and receives a reflected wave reflected by the object to detect the object. An antenna device capable of transmitting and/or receiving an electromagnetic wave is typically applied to such an electromagnetic wave sensor. As an example of the antenna device, for example, there is a proposal of a single antenna including a dielectric substrate, a signal conversion portion arranged on a front surface of the dielectric substrate, and a ground plate arranged on a back surface of the dielectric substrate (see Patent Literature 1).

### CITATION LIST

### Patent Literature

[PTL 1] JP 6955590 B2

### SUMMARY OF THE INVENTION

In recent years, applications of the electromagnetic wave sensor have been expanding, and the use of the electromagnetic wave sensor as a human presence sensor is being considered. However, when the single antenna as described in Patent Literature 1 is applied to the human presence sensor, a resolution required of the human presence sensor may not be sufficiently achieved. The resolution of the electromagnetic wave sensor depends on the width of a frequency range (hereinafter referred to as “band”) of electromagnetic waves that can be used in the antenna device. Thus, it is expected to broaden the band of electromagnetic waves that can be used by the antenna device.

A primary object of the present disclosure is to provide an antenna device with which it is possible to broaden a band of electromagnetic waves that can be used.

[1] An antenna device according to an embodiment of the present disclosure includes an inorganic material substrate, a first conductor layer, a supporting substrate, a cavity portion, and a ground conductor layer. The first conductor layer is arranged on one side of the inorganic material substrate in a thickness direction of the inorganic material substrate. The first conductor layer includes a patch antenna. The supporting substrate is arranged on an opposite side to the first conductor layer with respect to the inorganic material substrate. The cavity portion is arranged on the opposite side to the first conductor layer with respect to the inorganic material substrate and is arranged on the inorganic material substrate side of the supporting substrate. The ground conductor layer is arranged in the cavity portion. The ground conductor layer is capable of generating an electric field between the ground conductor layer and the patch antenna. A thickness “t” of the inorganic material substrate satisfies the below-indicated expression (1). When the patch antenna is projected in the thickness direction of the inorganic material substrate, at least a part of a projection surface of the patch antenna overlaps with the cavity portion:

$$t < \frac{λ}{a \sqrt{ε}} \qquad ( 1 )$$

where “t” represents the thickness of the inorganic material substrate, λ represents a wavelength of an electromagnetic wave transmitted and/or received by the antenna device, ε represents a relative dielectric constant of the inorganic material substrate, and “a” represents a numerical value of 3 or more.

[2] In the antenna device according to the above-mentioned item [1], when the patch antenna is projected in the thickness direction of the inorganic material substrate, the entire projection surface of the patch antenna may overlap with the cavity portion.

[3] In the antenna device according to the above-mentioned item [1] or [2], the first conductor layer may further include a transmission line. The transmission line is connected to the patch antenna.

[4] The antenna device according to the above-mentioned item [3] may further include a first ground layer. The first ground layer is arranged between the inorganic material substrate and the supporting substrate and in a part different from the cavity portion. When the transmission line is projected in the thickness direction of the inorganic material substrate, at least a part of a projection surface of the transmission line overlaps with the first ground layer.

[5] The antenna device according to the above-mentioned item [4] may further include a joint portion. The joint portion is configured to join the inorganic material substrate and the supporting substrate to each other.

[6] In the antenna device according to the above-mentioned item [5], the joint portion may include a first joint layer and a second joint layer. The first joint layer is arranged on a surface of the inorganic material substrate on the opposite side to the first conductor layer in the thickness direction of the inorganic material substrate. The second joint layer is arranged on a surface of the first ground layer on an opposite side to the supporting substrate in the thickness direction of the inorganic material substrate. The second joint layer is joined to the first joint layer.

[7] In the antenna device according to any one of the above-mentioned items [1] to [6], the thickness “t” of the inorganic material substrate may be 100 μm or less.

[8] In the antenna device according to any one of the above-mentioned items [1] to [7], a frequency of the electromagnetic wave transmitted and/or received by the antenna device may be from 20 GHz to 20 THz.

[9] In the antenna device according to any one of the above-mentioned items [1] to [8], the inorganic material substrate may be formed of quartz glass.

In the antenna device according to any one of the above-mentioned items [1] to [9], the supporting substrate may be formed of silicon.

According to the embodiments of the present disclosure, it is possible to broaden the band of electromagnetic waves that can be used.

### BRIEF DESCRIPTION OF THE DRAWINGS

FIG. 1 is a schematic perspective view of an antenna device according to an embodiment of the present disclosure.

FIG. 2 is a cross-sectional view of the antenna device taken along the line II-II′ of FIG. 1.

FIG. 3 is a schematic perspective view of an antenna device according to another embodiment of the present disclosure.

FIG. 4 is a schematic perspective view of an antenna device according to still another embodiment of the present disclosure.

FIG. 5 is a schematic perspective view of an antenna device according to yet another embodiment of the present disclosure.

FIG. 6 is a schematic perspective view of an antenna device according to still yet another embodiment of the present disclosure.

FIG. 7 is a schematic perspective view of a supporting substrate and a second conductor layer included in the antenna device of FIG. 1.

FIG. 8 is a schematic perspective view for illustrating another embodiment of the second conductor layer of FIG. 7.

FIG. 9 is a schematic perspective view for illustrating still another embodiment of the second conductor layer of FIG. 7.

FIG. 10 is a graph for showing an S11 parameter in an antenna device of Example 1.

FIG. 11 is a graph for showing an S11 parameter in an antenna device of Comparative Example 1.

### DESCRIPTION OF THE EMBODIMENTS

Embodiments of the present disclosure are described below with reference to the drawings. However, the present disclosure is not limited to these embodiments. In addition, the drawings may be represented schematically in terms of width, thickness, shape, and the like of each component compared to the embodiments in order to make the description clearer, but this is only an example and does not limit the interpretation of the present disclosure.

### A. Overall Configuration of Antenna Device

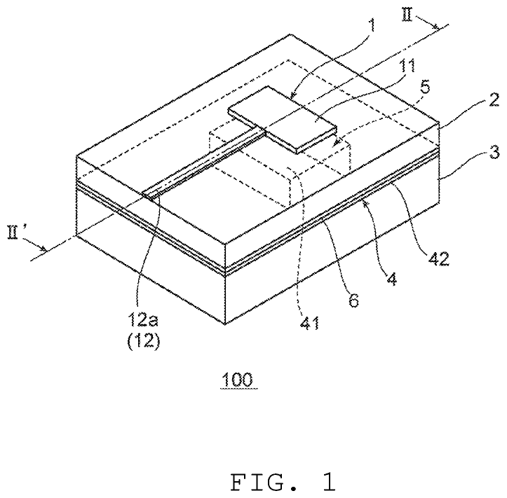

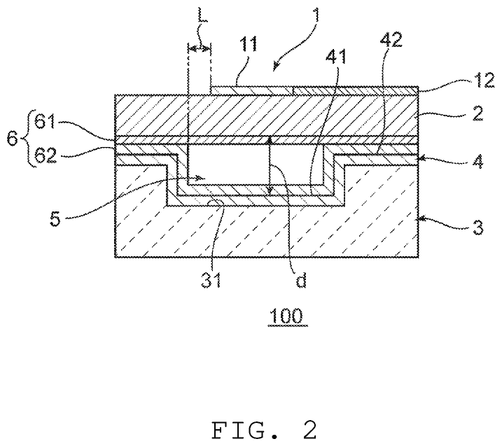

FIG. 1 is a schematic perspective view of an antenna device according to one embodiment of the present disclosure, and FIG. 2 is a cross-sectional view of the antenna device taken along the line II-II′ of FIG. 1.

An antenna device 100 is typically capable of transmitting and/or receiving an electromagnetic wave that is a millimeter wave/terahertz wave. The “millimeter wave” is typically an electromagnetic wave having a frequency of from about 20 GHz to about 300 GHZ, and the “terahertz wave” is typically an electromagnetic wave having a frequency of from about 300 GHz to about 20 THz.

A frequency of the electromagnetic wave that can be transmitted and/or received by the antenna device is from 20 GHZ to 20 THz in one example, is from 20 GHz to 500 GHz in another example, is from 20 GHz to 300 GHz in still another example, and is from 100 GHz to 200 GHz in yet another example.

The antenna device 100 includes an inorganic material substrate 2, a first conductor layer 1, a supporting substrate 3, a cavity portion 5, and a ground conductor layer 41. The first conductor layer 1 is arranged on one side of the inorganic material substrate 2 in the thickness direction of the inorganic material substrate 2. The first conductor layer 1 includes a patch antenna 11. The supporting substrate 3 is arranged on an opposite side to the first conductor layer 1 with respect to the inorganic material substrate 2. The cavity portion 5 is arranged on the opposite side to the first conductor layer 1 with respect to the inorganic material substrate 2 and is arranged on the inorganic material substrate side of the supporting substrate 3. The ground conductor layer 41 is arranged in the cavity portion 5. The patch antenna 11, the ground conductor layer 41, and the inorganic material substrate 2 positioned therebetween typically form a planar antenna. The ground conductor layer 41 is capable of generating an electric field between the ground conductor layer 41 and the patch antenna 11. More specifically, when the patch antenna 11 receives and/or transmits the above-mentioned high-frequency electromagnetic wave, the ground conductor layer 41 generates the electric field between the patch antenna 11 and the ground conductor layer 41. A thickness “t” of the inorganic material substrate 2 satisfies the below-indicated expression (1). When the patch antenna 11 is projected in the thickness direction of the inorganic material substrate 2, at least a part of a projection surface of the patch antenna 11 overlaps with the cavity portion 5:

$$t < \frac{λ}{a \sqrt{ε}} \qquad ( 1 )$$

where “t” represents the thickness of the inorganic material substrate 2, λ represents a wavelength of the electromagnetic wave transmitted and/or received by the antenna device 100, ε represents a relative dielectric constant of the inorganic material substrate 2, and “a” represents a numerical value of 3 or more.

With such a configuration, the thickness of the inorganic material substrate 2 satisfies the above-mentioned expression (1), and hence, even in a case in which the antenna device 100 transmits and/or receives the above-mentioned high-frequency electromagnetic wave, the inducement of a slab mode can be suppressed, and the resonance of the inorganic material substrate 2 can be suppressed. Further, when the patch antenna 11 is projected in the thickness direction of the inorganic material substrate 2, at least a part of the projection surface of the patch antenna 11 overlaps with the cavity portion 5, and hence the band of frequencies (resonant frequencies) that can resonate between the patch antenna 11 and the ground conductor layer 41 can be broadened, and as a result, the band of frequencies emitted from the antenna device 100 can be broadened.

With those effects, a return loss of the electromagnetic wave in the antenna device 100 can be sufficiently reduced. As a result, in the antenna device 100, a bandwidth of the electromagnetic wave in which the return loss is sufficiently small, that is, the bandwidth of the electromagnetic wave in which an S11 parameter representing the return loss is a predetermined value or less, can be broadened. In short, the antenna device 100 can function as a broadband antenna.

In one embodiment, the bandwidth of the electromagnetic wave in which the S11 parameter of the antenna device 100 (return loss) is −10 dB or less (−10 dB bandwidth) is, for example, 5.0 GHz or more, preferably 8.0 GHz or more, more preferably 10.0 GHz or more, still more preferably 13.0 GHz or more.

Meanwhile, an upper limit of the −10 dB bandwidth of the antenna device 100 is typically 50 GHZ. The S11 parameter is measured by, for example, a network analyzer.

In addition, the antenna device 100 is being developed to be downsized, and is expected to integrate circuits in the future, and hence accompanying downsizing of the antenna device 100 is predicted to be required as well. In the antenna device 100 described above, the thickness of the inorganic material substrate 2 satisfies the above-mentioned expression (1), and thinning of the inorganic material substrate 2 is achieved, and hence the demand for downsizing can also be met while the band to be used in the antenna device 100 is broadened.

A ratio of an area of the part of the above-mentioned projection surface of the patch antenna 11 that overlaps with the cavity portion 5 is, for example, 70% or more, preferably 80% or more, more preferably 90% or more. When the projection surface of the patch antenna 11 overlaps with the cavity portion 5 at the above-mentioned area ratio, it is possible to stably broaden the band to be used in the antenna device 100.

In one embodiment, when the patch antenna 11 is projected in the thickness direction of the inorganic material substrate 2, the entire projection surface of the patch antenna 11 overlaps with the cavity portion 5. In other words, the ratio of the area of the part of the projection surface of the patch antenna 11 that overlaps with the cavity portion 5 is 100%. With such a configuration, it is possible to stably broaden the band to be used in the antenna device 100.

In one embodiment, when each of the patch antenna 11 and the cavity portion 5 is projected in the thickness direction of the inorganic material substrate 2, a projected area of the cavity portion 5 is a projected area of the patch antenna 11 or more. The projected area of the cavity portion 5 is, for example, one to four times the projected area of the patch antenna 11, preferably one to three times the projected area of the patch antenna 11. When the projected area of the cavity portion 5 has such a relationship with the projected area of the patch antenna 11, the patch antenna 11 can easily be positioned such that the patch antenna 11 overlaps with the cavity portion 5 as viewed from the thickness direction of the inorganic material substrate 2. Thus, it is possible to increase the degree of freedom in design of the patch antenna 11, and it is also possible to more stably broaden the band to be used in the antenna device 100.

In the illustrated example, when each of the patch antenna 11 and the cavity portion 5 is projected in the thickness direction of the inorganic material substrate 2, an outer edge of the projection surface of the cavity portion 5 is positioned at a distance from an outer edge of the projection surface of the patch antenna 11. As illustrated in FIG. 2, in a direction normal to the outer edge of the projection surface of the patch antenna 11, a distance L between the outer edge of the projection surface of the cavity portion 5 and the outer edge of the projection surface of the patch antenna 11 is from 0 μm to λ/2ε μm in one example, and is from 0 μm to λ/4ε μm in another example, where ε represents the relative dielectric constant of the inorganic material substrate 2. When the distance L between the outer edge of the cavity portion 5 and the outer edge of the patch antenna 11 falls within such a range, it is possible to further increase the degree of freedom in design of the patch antenna 11, and it is also possible to still more stably broaden the band to be used in the antenna device 100.

As illustrated in FIG. 1, the patch antenna 11 has any appropriate shape. Examples of the shape of the patch antenna 11 as viewed from the thickness direction of the inorganic material substrate 2 include a triangle, a quadrangle, a pentagon, a substantial polygon having six or more sides, a substantially circular shape, and a substantially oval shape. In the illustrated example, the patch antenna 11 has a substantially rectangular shape as viewed from the thickness direction of the inorganic material substrate 2.

The cavity portion 5 has any appropriate shape. Examples of the shape of the cavity portion 5 as viewed from the thickness direction of the inorganic material substrate 2 include the same shapes as the above-mentioned shapes of the patch antenna 11.

In one embodiment, the cavity portion 5 has a shape similar to that of the patch antenna 11 as viewed from the thickness direction of the inorganic material substrate 2. In the illustrated example, the cavity portion 5 and the patch antenna 11 have shapes that are similar to each other, and a center of the patch antenna 11 and a center of the cavity portion 5 are positioned on the same axis along the thickness direction of the inorganic material substrate 2.

In one embodiment, the first conductor layer 1 further includes a transmission line 12 in addition to the patch antenna 11. The transmission line 12 is connected to the patch antenna 11. An end portion of the transmission line 12 on the opposite side to the patch antenna 11 is typically configured to be connectable to an external apparatus. With such a configuration, an electric signal input from the external apparatus can be supplied to the patch antenna 11 via the transmission line 12. When the electric signal is supplied to the patch antenna 11, the patch antenna 11 and the ground conductor layer 41 can convert the electric signal into an electromagnetic wave. Accordingly, the patch antenna 11 can emit the electromagnetic wave converted from the electric signal. Further, when the patch antenna 11 receives an electromagnetic wave, the patch antenna 11 and the ground conductor layer 41 can convert the electromagnetic wave into an electric signal. Accordingly, the antenna device 100 can transmit the electric signal converted from the electromagnetic wave to the external apparatus via the transmission line 12.

The transmission line 12 typically has a flat strip shape extending in a predetermined direction. A width of the transmission line 12 is, for example, from 2 μm to 800 μm. When the patch antenna 11 has a substantially rectangular shape, the direction in which the transmission line 12 extends is typically substantially parallel to a width direction of the patch antenna 11.

In one embodiment, impedance matching is achieved between the patch antenna 11 and the transmission line 12.

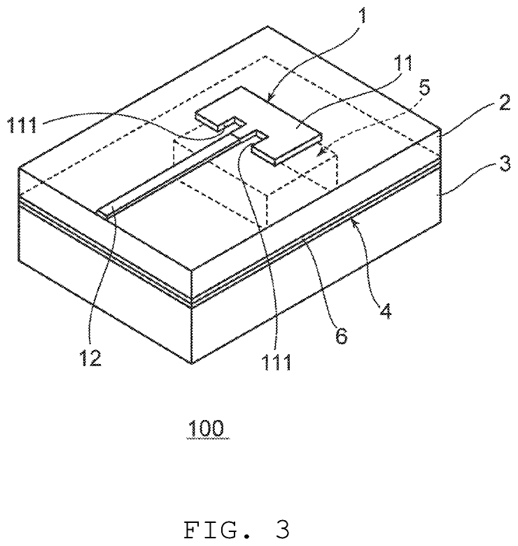

As illustrated in FIG. 3, the patch antenna 11 may include a cutout portion 111. The cutout portion 111 is arranged so as to be adjacent to a portion of the patch antenna 11 that is connected to the transmission line 12. The cutout portion 111 has any appropriate configuration. The cutout portion 111 is recessed inward from the outer edge of the patch antenna 11.

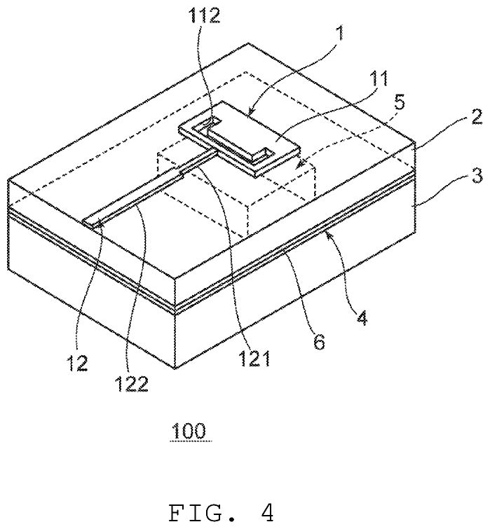

Further, as illustrated in FIG. 4, the patch antenna 11 may include a slit 112. The slit 112 penetrates through the patch antenna 11 in its thickness direction. The slit 112 has any appropriate configuration. In the illustrated example, the slit 112 has a substantially U shape as viewed from the thickness direction of the inorganic material substrate 2.

Further, the transmission line 12 may include a narrow portion 121 and a wide portion 122. The narrow portion 121 is positioned at an end portion of the transmission line 12 on the patch antenna 11 side. The narrow portion 121 is connected to the patch antenna 11. A width of the narrow portion 121 is smaller than a width of the wide portion 122. The width of the narrow portion 121 is adjusted suitably and appropriately. The wide portion 122 is positioned on an opposite side to the patch antenna 11 with respect to the narrow portion 121. A range of the width of the wide portion 122 is, for example, the same as the above-mentioned range of the width of the transmission line 12.

As illustrated in FIG. 1 and FIG. 2, in one embodiment, the transmission line 12 forms a waveguide capable of propagating the electromagnetic wave. With this configuration, the electromagnetic wave can be supplied to the patch antenna 11. In the illustrated example, the transmission line 12 forms microstrip line together with a first ground layer 42. The transmission line 12 forming the microstrip line is hereinafter sometimes referred to as “MS-type signal wiring 12a.” The antenna device 100 includes the patch antenna 11, the ground conductor layer 41, the MS-type signal wiring 12a, and the first ground layer 42, and forms a microstrip patch antenna.

A width of the MS-type signal wiring 12a is, for example, from 20 μm to 800 μm, preferably from 50 μm to 500 μm.

The first ground layer 42 is typically arranged between the inorganic material substrate 2 and the supporting substrate 3 and in a part different from the cavity portion 5. When the transmission line 12 (MS-type signal wiring 12a) is projected in the thickness direction of the inorganic material substrate 2, at least a part of a projection surface of the transmission line 12 overlaps with the first ground layer 42.

With such a configuration, when a voltage is applied to the

MS-type signal wiring 12a and the first ground layer 42, an electric field is generated between the MS-type signal wiring 12a and the first ground layer 42. Accordingly, an electromagnetic wave input from the external apparatus can couple to the electric field generated between the MS-type signal wiring 12a and the first ground layer 42 and be propagated through the inorganic material substrate 2 to reach the patch antenna 11. Further, when the patch antenna 11 receives an electromagnetic wave, the electromagnetic wave can be propagated through the inorganic material substrate 2 owing to the electric field generated between the MS-type signal wiring 12a and the first ground layer 42 to be transmitted to the external apparatus.

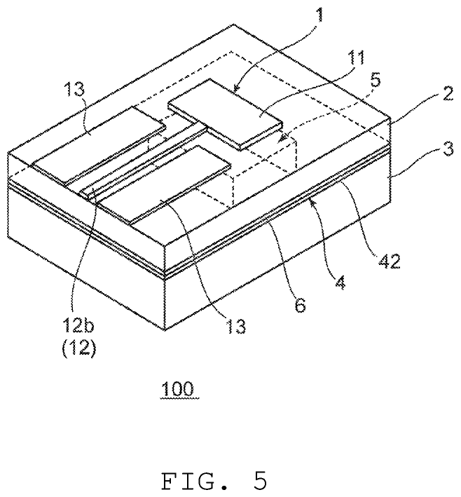

Further, as illustrated in FIG. 5, in another embodiment, the transmission line 12 forms a coplanar line together with second ground layers 13. In this embodiment, the first conductor layer 1 further includes the second ground layers 13. The transmission line 12 forming the coplanar line is hereinafter sometimes referred to as “CP-type signal wiring 12b.” The antenna device 100 includes the patch antenna 11, the ground conductor layer 41, the CP-type signal wiring 12b, and the second ground layers 13, and forms a coplanar patch antenna.

A width of the CP-type signal wiring 12b is, for example, from 2 μm to 200 μm, preferably from 20 μm to 150 μm.

The second ground layers 13 are arranged so as to sandwich the transmission line 12 in a direction orthogonal to the direction in which the transmission line 12 (CP-type signal wiring 12b) extends. In the direction orthogonal to the direction in which the transmission line 12 extends, a clearance (slit) is formed between each of the second ground layers 13 and the transmission line 12 (CP-type signal wiring 12b). A width of the clearance is, for example, from 2 μm to 100 μm, preferably from 5 μm to 80 μm.

With such a configuration, when a voltage is applied to the CP-type signal wiring 12b, an electric field is generated between the CP-type signal wiring 12b and the second ground layers 13. Accordingly, an electromagnetic wave input from the external apparatus can couple to the electric field generated between the CP-type signal wiring 12b and the second ground layers 13 and be propagated through the inorganic material substrate 2 to reach the patch antenna 11. Further, when the patch antenna 11 receives an electromagnetic wave, the electromagnetic wave can be propagated through the inorganic material substrate 2 owing to the electric field generated between the CP-type signal wiring 12b and the second ground layers 13 to be transmitted to the external apparatus.

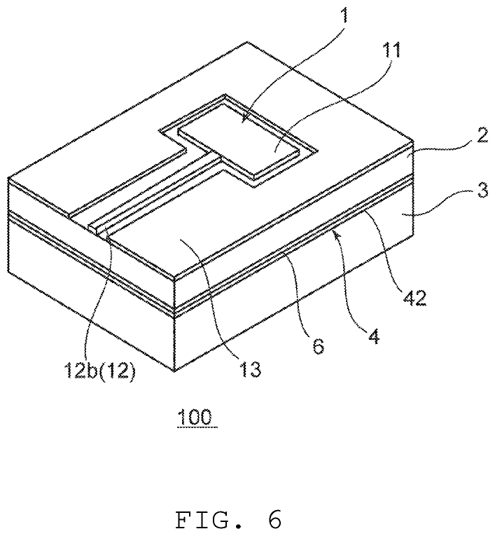

Further, as illustrated in FIG. 6, the second ground layer 13 may be arranged so as to surround the patch antenna 11 in addition to the transmission line 12. In this case, the above-mentioned clearance (slit) is formed between the second ground layer 13 and the patch antenna 11. With this configuration, the antenna can be formed with the design different from that of the configuration of FIG. 5.

Further, the antenna device 100 including the CP-type signal wiring 12b preferably further includes the above-mentioned first ground layer 42. With such a configuration, it is possible to prevent the electric field generated between the CP-type signal wiring 12b and the second ground layer 13 from leaking to the supporting substrate 3. Moreover, it is possible to sufficiently suppress the occurrence of resonance and/or stray capacitance, and to suppress a change in antenna characteristics due to a variation in dimensions.

Although not shown, the first ground layer 42 and the second ground layer 13 may be electrically connected to each other. When the first ground layer 42 and the second ground layer 13 are electrically connected to each other, ground can be strengthened, and hence stray capacitance due to a line or an device in the surroundings can be suppressed. In one embodiment, a plurality of via holes are formed in the inorganic material substrate 2, and a via is formed in each of the via holes so that the first ground layer 42 and the second ground layer 13 are short-circuited to each other.

As used herein, the “antenna device” includes both of a wafer in which at least one antenna device is formed (antenna device wafer) and a chip obtained by cutting the antenna device wafer.

### B. Details of Antenna Device

Referring to FIG. 1 and FIG. 2, details of each member of the antenna device 100 are described below.

### B-1. Inorganic Material Substrate

The inorganic material substrate 2 has an upper surface on which the first conductor layer 1 is arranged, and a lower surface positioned inside the antenna device 100. The thickness “t” of the inorganic material substrate 2 satisfies the above-mentioned expression (1). In the expression (1), “a” preferably represents a numerical value of 6 or more.

The thickness of the inorganic material substrate 2 is, for example, 1 μm or more, preferably 2 μm or more, more preferably 10 μm or more, still more preferably 20 μm or more, particularly preferably 30 μm or more, more particularly preferably 40 μm or more. When the thickness of the inorganic material substrate 2 is smaller than such lower limits, the thickness and size of an electrode included in the transmission line 12 are reduced to about several micrometers, and it becomes difficult to achieve impedance matching with the patch antenna 11. Further, a tolerance in transmission performance due to manufacturing variations is significantly reduced in some cases.

Meanwhile, the thickness of the inorganic material substrate 2 is, for example, 500 μm or less, preferably 200 μm or less, more preferably 100 μm or less, still more preferably 80 μm or less, particularly preferably 60 μm or less.

When the thickness of the inorganic material substrate 2 is such upper limits or lower, the inducement of a slab mode and/or the resonance of the inorganic material substrate 2 can be stably suppressed. Accordingly, a return loss at the time when the antenna device 100 transmits and/or receives the electromagnetic wave can be further reduced. As a result, it is possible to broaden the bandwidth of the electromagnetic wave (typically, −10 dB bandwidth) in which a reflection characteristic is sufficiently small in the antenna device 100, and it is thus possible to further broaden the band to be used in the antenna device 100.

The relative dielectric constant & of the inorganic material substrate 2 at 300 GHz, is, for example, 12.0 or less, preferably 10.0 or less, more preferably 5.0 or less. A lower limit of the relative dielectric constant ε of the inorganic material substrate 2 at 300 GHz is typically 3.5. A dielectric loss tangent (dielectric loss) tan δ of the inorganic material substrate 2 at 300 GHz is, for example, 0.0030 or less, preferably 0.0020 or less, more preferably 0.0015 or less.

When the relative dielectric constant & and the dielectric loss tangent (dielectric loss) tan δ of the inorganic material substrate 2 fall within such ranges, the return loss in the antenna device 100 can be further reduced. The relative dielectric constant & and the dielectric loss tangent (dielectric loss) tan δ can be measured by, for example, terahertz time domain spectroscopy. In addition, herein, when a measurement frequency is not mentioned with regard to the relative dielectric constant and the dielectric loss tangent, the relative dielectric constant and the dielectric loss tangent at 300 GHz are meant.

The inorganic material substrate 2 is formed of an inorganic material. Any appropriate material may be employed as the inorganic material as long as the effects according to the embodiments of the present disclosure are obtained. Examples of the inorganic material for forming the inorganic material substrate 2 include monocrystalline quartz (relative dielectric constant: 4.5, dielectric loss tangent: 0.0013), amorphous quartz (quartz glass, relative dielectric constant: 3.8, dielectric loss tangent: 0.0010), spinel (relative dielectric constant: 8.3, dielectric loss tangent: 0.0020), AlN (relative dielectric constant: 8.5, dielectric loss tangent: 0.0015), sapphire (relative dielectric constant: 9.4, dielectric loss tangent: 0.0030), SiC (relative dielectric constant: 9.8, dielectric loss tangent: 0.0022), magnesium oxide (relative dielectric constant: 10.0, dielectric loss tangent: 0.0012), and silicon (relative dielectric constant: 11.7, dielectric loss tangent: 0.0016).

Of those inorganic materials, amorphous quartz (quartz glass) is preferred.

When the inorganic material substrate 2 is formed of quartz glass, the return loss in the antenna device 100 can be reduced more stably. Further, the quartz glass substrate has a large dielectric constant as compared to a resin-based substrate, and hence can be reduced in substrate size, and besides, has a relatively small dielectric constant among inorganic materials, and hence is advantageous in achieving a low delay. In addition, the first conductor layer 1 (metal layer) can be formed without surface roughening or surface treatment.

Although not shown, the inorganic material substrate 2 may be curved so that a part thereof that overlaps with the cavity portion 5 as viewed from the thickness direction sinks into the cavity portion 5.

### B-2. First Conductor Layer

In one embodiment, the first conductor layer 1 is arranged on a surface (one surface in its thickness direction) of the inorganic material substrate 2, and is brought into direct contact with the inorganic material substrate 2.

The first conductor layer 1 is typically formed of a metal. Examples of the metal include chromium (Cr), nickel (Ni), copper (Cu), and gold (Au). The metals may be used alone or in combination thereof. The first conductor layer 1 may be a single layer, or may be formed as a laminate of two or more layers. A thickness of the first conductor layer 1 is, for example, from 1 μm to 20 μm, preferably from 4 μm to 10 μm.

### B-3. Supporting Substrate

The supporting substrate 3 can impart excellent strength to the antenna device 100. In the illustrated example, the supporting substrate 3 supports the inorganic material substrate 2 via the first ground layer 42 and a joint portion 6 (described later). With this configuration, the inorganic material substrate 2 can be thinned as described above. The supporting substrate 3 has any appropriate configuration.

Examples of a material for forming the supporting substrate 3 include indium phosphide (InP), silicon (Si), glass, SiAlON (Si₃N₄—Al₂O₃), mullite (3Al₂O₃·2SiO₂, 2Al₂O₃·3SiO₂), aluminum nitride (AlN), magnesium oxide (MgO), aluminum oxide (Al₂O₃), spinel (MgAl₂O₄), sapphire, quartz, crystal, gallium nitride (GaN), silicon carbide (Sic), silicon nitride (Si₃N₄), and gallium oxide (Ga₂O₃).

A thermal conductivity of the material for forming the supporting substrate 3 is preferably 150 W/Km or more, more preferably 200 W/Km or more.

When the external apparatus (e.g., amplifier) is connected to the antenna device 100, the inorganic material substrate 2 may be heated by the external apparatus, and the heat of the inorganic material substrate 2 may adversely affect the external apparatus. In this regard, when the material for forming the supporting substrate 3 has the above-mentioned thermal conductivity, the supporting substrate 3 functions as a heat sink, and hence the heat of the inorganic material substrate 2 can be dissipated smoothly.

Of the materials for forming the supporting substrate 3, silicon (thermal conductivity: about 160 W/Km), silicon carbide (thermal conductivity: about 270 W/Km), and aluminum nitride (thermal conductivity: from about 150 W/Km to about 250 W/Km) are preferred from the viewpoint of the thermal conductivity.

Further, a linear expansion coefficient of the material for forming the supporting substrate 3 is preferably as close to a linear expansion coefficient of the material for forming the inorganic material substrate 2 as possible. The linear expansion coefficient of the material for forming the supporting substrate 3 falls within the range of, for example, from 50% to 150% with respect to the linear expansion coefficient of the material for forming the inorganic material substrate 2. When the linear expansion coefficient of the material for forming the supporting substrate 3 falls within such a range, thermal deformation (typically, warpage) of the antenna device 100 can be suppressed.

Of those materials for forming the supporting substrate 3, indium phosphide, silicon, aluminum nitride, gallium nitride, silicon carbide, and silicon nitride are preferred, silicon, aluminum nitride, gallium nitride, silicon carbide, and silicon nitride are more preferred, and silicon is particularly preferred.

As illustrated in FIG. 2, in one embodiment, the supporting substrate 3 includes a recess 31 corresponding to the cavity portion 5.

The recess 31 is typically recessed from an upper surface (surface on the inorganic material substrate 2 side) of the supporting substrate 3 downward (direction away from the inorganic material substrate 2). The recess 31 has, as viewed from the thickness direction of the inorganic material substrate 2, the same shape as that of the cavity portion 5 described above. In the illustrated example, the recess 31 has, in a cut surface obtained by cutting the supporting substrate 3 in its thickness direction, a substantially U shape that is open toward the inorganic material substrate 2. An internal surface of the recess 31 includes side surfaces and a bottom surface. The side surfaces of the recess 31 extend in the thickness direction of the inorganic material substrate 2. The direction in which the side surfaces of the recess 31 extend may be exactly identical to (that is, parallel to) the thickness direction of the inorganic material substrate 2, or may be slightly inclined with respect to the thickness direction of the inorganic material substrate 2. The bottom surface of the recess 31 extends in a direction that crosses (typically, a direction orthogonal to) the thickness direction of the inorganic material substrate 2.

### B-4. Second Conductor Layer

In one embodiment, the antenna device 100 further includes a second conductor layer 4 including the ground conductor layer 41. The second conductor layer 4 is arranged between the inorganic material substrate 2 and the supporting substrate 3. The second conductor layer 4 is typically arranged on the upper surface (surface on the inorganic material substrate 2 side) of the supporting substrate 3, and is brought into direct contact with the supporting substrate 3.

In the illustrated example, the ground conductor layer 41 included in the second conductor layer 4 is positioned in the recess 31 of the supporting substrate 3. The ground conductor layer 41 is arranged at least on the bottom surface of the recess 31. In the illustrated example, the ground conductor layer 41 is arranged on the entire internal surface of the recess 31. With this configuration, at least a part of the ground conductor layer 41 is arranged so as to be opposed to the patch antenna 11 in the thickness direction of the inorganic material substrate 2. Accordingly, the electric field can be stably generated between the patch antenna 11 and the ground conductor layer 41.

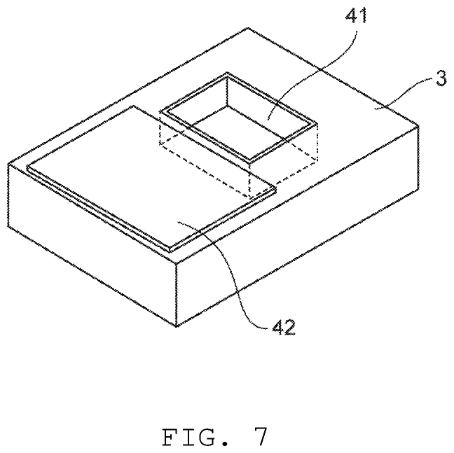

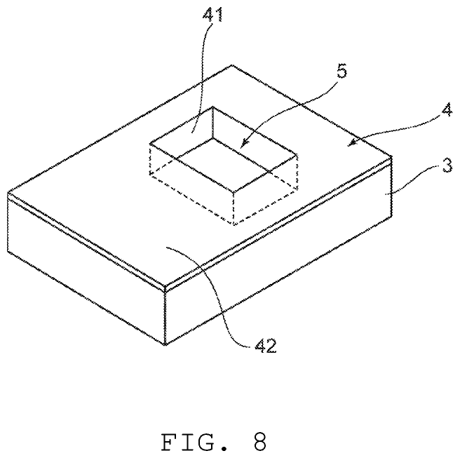

In one embodiment, the second conductor layer 4 further includes the first ground layer 42. The first ground layer 42 is arranged at any appropriate position as long as the first ground layer 42 overlaps with at least a part of the projection surface of the transmission line 12 as described above. The first ground layer 42 is arranged on a part of the upper surface (surface on the inorganic material substrate 2 side) of the supporting substrate 3 that excludes the recess 31. The first ground layer 42 may be partially arranged on the part of the upper surface of the supporting substrate 3 that excludes the recess 31 (see FIG. 7), or may be arranged on the entire part of the upper surface of the supporting substrate 3 that excludes the recess 31 (see FIG. 8).

As illustrated in FIG. 8, in one embodiment, the first ground layer 42 is arranged on the entire part of the upper surface of the supporting substrate 3 that excludes the recess 31. In the illustrated example, the first ground layer 42 and the ground conductor layer 41 are continuous with each other. When the ground conductor layer 41 and the first ground layer 42 are continuous with each other to form the second conductor layer 4, the function of the ground becomes stable in the entire substrate, and hence the antenna device 100 can easily be designed and manufactured.

The second conductor layer 4 is, for example, formed of the same metal as that of the first conductor layer 1.

A thickness of the second conductor layer 4 is typically smaller than the thickness of the first conductor layer 1. The thickness of the second conductor layer 4 is, for example, from 1 nm to 30 μm, preferably from 10 nm to 10 μm.

### B-5. Joint Portion

As illustrated in FIG. 1 and FIG. 2, in one embodiment, the antenna device 100 further includes the joint portion 6. The joint portion 6 joins the inorganic material substrate 2 and the supporting substrate 3 to each other. In the illustrated example, the joint portion 6 joins the inorganic material substrate 2 and the supporting substrate 3 on which the first ground layer 42 is arranged to each other, and is positioned between the inorganic material substrate 2 and the first ground layer 42.

The joint portion 6 may be formed of an organic material (typically, an organic adhesive), or may be formed of an inorganic material.

In one embodiment, the joint portion 6 is formed of an inorganic material. Examples of the inorganic material for forming the joint portion 6 include SiO₂, amorphous silicon, and tantalum oxide, and amorphous silicon is preferred. A thickness of the joint portion 6 is, for example, from 0.001 μm to 10 μm, preferably from 0.01 μm to 3 μm.

In one embodiment, the inorganic material substrate 2 and the supporting substrate 3 on which the first ground layer 42 is formed are directly joined to each other. With this configuration, the joint portion 6 is formed between the inorganic material substrate 2 and the first ground layer 42. As used herein, the term “direct joining” means that two layers or substrates are joined to each other without an organic material (typically, an organic adhesive) being interposed therebetween. The form of the direct joining may be appropriately set in accordance with the configurations of the layers or substrates to be joined to each other. Further, an interface joined by the direct joining is typically amorphized. Accordingly, the thermal resistance of the joining interface can be dramatically reduced as compared to resin joining. Thus, in the case in which the external apparatus is connected to the antenna device 100, even when heat generated from the external apparatus is transferred to the inorganic material substrate 2, such heat can be smoothly allowed to escape from the inorganic material substrate 2 to a package via the supporting substrate 3. As a result, the heat can be efficiently dissipated from the inorganic material substrate 2, and a degradation in characteristics of the external apparatus can be suppressed.

Further, when those components are integrated by the direct joining, peeling in the antenna device 100 can be satisfactorily suppressed, and as a result, damage (e.g., a crack) to the inorganic material substrate 2 resulting from such peeling can be satisfactorily suppressed.

Further, when those components are integrated by the direct joining without the interposition of a resin, heat resistance and chemical resistance in a back-end process of the manufacture can be improved, and hence the deterioration of antenna characteristics due to heat and moisture absorption in the antenna device 100 can be suppressed.

The joint portion 6 may have a single-layer structure, or may have a laminate structure. As illustrated in FIG. 2, in one embodiment, the joint portion 6 has a laminate structure. The joint portion 6 includes a first joint layer 61 and a second joint layer 62.

The first joint layer 61 is arranged on a surface of the inorganic material substrate 2. More specifically, the first joint layer 61 is arranged on a surface of the inorganic material substrate 2 on the opposite side to the first conductor layer 1 in the thickness direction of the inorganic material substrate 2. In the illustrated example, the first joint layer 61 is arranged on the lower surface (surface on the opposite side to the first conductor layer 1) of the inorganic material substrate 2, and is brought into direct contact with the inorganic material substrate 2. The first joint layer 61 may be partially arranged on the lower surface of the inorganic material substrate 2, or may be arranged on the entire lower surface of the inorganic material substrate 2. In the illustrated example, the first joint layer 61 is arranged on the entire lower surface of the inorganic material substrate 2.

A thickness of the first joint layer 61 is, for example, from 0.5 nm to 5 μm, preferably from 0.01 μm to 1.5 μm, more preferably from 0.01 μm to 0.05 μm.

The second joint layer 62 is arranged on a surface of the first ground layer 42. More specifically, the second joint layer 62 is arranged on a surface of the first ground layer 42 on an opposite side to the supporting substrate 3 in the thickness direction of the inorganic material substrate 2. In the illustrated example, the second joint layer 62 is arranged on an upper surface (surface on the opposite side to the supporting substrate 3) of the first ground layer 42, and is brought into direct contact with the first ground layer 42. The second joint layer 62 may be arranged only on the first ground layer 42, or may be arranged on the ground conductor layer 41 in addition to the first ground layer 42. In the illustrated example, the second joint layer 62 is arranged on the entire upper surface of each of the ground conductor layer 41 and the first ground layer 42. In other words, the second joint layer 62 is stacked on the entire second conductor layer 4.

The range of a thickness of the second joint layer 62 is the same as, for example, the above-mentioned range of the thickness of the first joint layer 61.

The second joint layer 62 is joined to the first joint layer 61 to be integrated with the first joint layer 61. In the illustrated example, a part of the second joint layer 62 that is positioned on the first ground layer 42 is directly joined to the first joint layer 61.

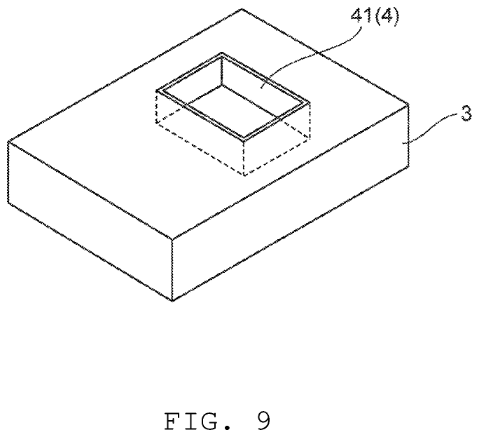

As illustrated in FIG. 9, the second conductor layer 4 may be formed of only the ground conductor layer 41 without including the first ground layer 42. In this case, although not shown, the joint portion 6 is positioned between the part of the upper surface of the supporting substrate 3 that excludes the recess 31, and the inorganic material substrate 2 to join the part and the inorganic material substrate 2 to each other.

### B-6. Cavity Portion

As illustrated in FIG. 2, in one embodiment, the cavity portion 5 is positioned in a region surrounded by the inorganic material substrate 2 and the ground conductor layer 41. The cavity portion 5 is formed of a groove formed in the supporting substrate 3. The cavity portion 5 is defined by the lower surface of the inorganic material substrate 2 or the first joint layer 61 arranged on the lower surface of the inorganic material substrate 2, and the upper surface of the ground conductor layer 41 or the second joint layer 62 arranged on the upper surface of the ground conductor layer 41. In the illustrated example, the cavity portion 5 is defined by the first joint layer 61 arranged on the lower surface of the inorganic material substrate 2, and the second joint layer 62 arranged on the upper surface of the ground conductor layer 41.

Air is typically present in the cavity portion 5. In another embodiment, the cavity portion 5 is in a vacuum state.

A dimension “d” (hereinafter referred to as “depth ‘d’”) of the cavity portion 5 in the thickness direction of the inorganic material substrate 2 is changed suitably and appropriately in accordance with the configuration of the antenna device 100 and the frequency of the electromagnetic wave transmitted and/or received by the antenna device 100. The depth “d” of the cavity portion 5 is, for example, from 1 μm to 250 μm. The depth “d” of the cavity portion 5 refers to a distance in the thickness direction of the inorganic material substrate 2 between the lower surface (surface on the opposite side to the first conductor layer 1) of the inorganic material substrate 2 and the upper surface (surface on the opposite side to the supporting substrate 3) of the ground conductor layer 41.

In one embodiment, when the patch antenna 11 has a rectangular shape, and the antenna device 100 transmits and receives the electromagnetic wave having a frequency of from 100 GHz to 200 GHz, the depth “d” of the cavity portion 5 is, for example, from 5 μm to 250 μm.

In another embodiment, when the patch antenna 11 has a rectangular shape, and the antenna device 100 transmits and receives the electromagnetic wave having a frequency of from 250 GHz to 350 GHZ, the depth “d” of the cavity portion 5 is, for example, from 5 μm to 200 μm.

### C. Method of Manufacturing Antenna Device

Next, referring to FIG. 2, one embodiment of a method of manufacturing the antenna device 100 is described.

In one embodiment, first, the supporting substrate 3 including the recess 31 is prepared. The recess 31 is formed in the supporting substrate 3 by, for example, reactive ion etching.

Then, the second conductor layer 4 is formed on the upper surface of the supporting substrate 3 in which the recess 31 is formed. Any appropriate film formation method may be employed as a method of forming the second conductor layer 4. Examples of the film formation method include sputtering, plating, and vapor deposition, and plating is preferred.

Then, the inorganic material substrate 2 is prepared, and the inorganic material substrate 2 and the supporting substrate 3 are directly joined to each other. More specifically, the first joint layer 61 is formed on the lower surface of the inorganic material substrate 2. Further, the second joint layer 62 is formed on the upper surface of the second conductor layer 4. Examples of a method of forming those layers include sputtering, plating, and vapor deposition, and sputtering is preferred. The surface of each of the first joint layer 61 and the second joint layer 62 is polished to be planarized as required.

The direct joining may be achieved by, for example, the following procedure. In a high-vacuum chamber (e.g., about 1×10⁻⁶ Pa), the joining surface of each of components (layers or substrates) to be joined to each other is irradiated with a neutralized beam. In one embodiment, when the surface activation with a neutralized beam is performed, an inert gas is introduced into a chamber, and a high voltage is applied from a DC power source to an electrode arranged in the chamber. With such a configuration, an electric field generated between the electrode (positive electrode) and the chamber (negative electrode) causes electrons to move to generate atomic and ion beams derived from the inert gas. Among the beams that have reached a grid, the ion beam is neutralized at the grid, and hence a beam of neutral atoms is emitted from a high-speed atomic beam source. An atomic species for forming the beam is preferably an inert gas element (e.g., argon (Ar) or nitrogen (N)). At the time of the activation by beam irradiation, a voltage is, for example, from 0.5 kV to 2.0 kV, and a current is, for example, from 50 mA to 200 mA. A period of time of the irradiation with the neutralized beam is, for example, from 10 seconds to 300 seconds, preferably from 30 seconds to 120 seconds.

With this irradiation, each joining surface, more specifically, the inorganic material existing on each of the beam-irradiated surfaces, is activated.

Then, in a vacuum atmosphere at ordinary temperature (23° C.), the activated joining surfaces are brought into contact with each other. A load at the time of the contact may be, for example, from 100 N to 20,000 N. Consequently, the first joint layer 61 and the second joint layer 62 are joined to each other, and the joint portion 6 is formed.

With those steps, a laminate having the structure of the inorganic material substrate 2/the joint portion 6/the second conductor layer 4/the supporting substrate 3 is obtained. The method for the direct joining is not limited thereto, and, for example, a surface activation method using a fast atom beam (FAB) or an ion gun, an atomic diffusion method, or a plasma joining method may be applied.

The laminate is subjected to heating treatment as required. With this treatment, an increase in the joining strength between the inorganic material substrate and the supporting substrate can be achieved. A temperature of the heating is, for example, from 60° C. to 140° C., preferably from 80° C. to 120° C. A period of time of the heating is, for example, from 10 minutes to 5 hours, preferably from 30 minutes to 3 hours.

After that, as required, the inorganic material substrate 2 is polished to be thinned so as to have the above-mentioned thickness. Examples of the polishing method include chemical mechanical polishing (CMP).

Then, the first conductor layer 1 is formed on the upper surface of the inorganic material substrate 2. In one embodiment, after a resist having an opening corresponding to the first conductor layer is formed on the upper surface of the inorganic material substrate 2, the first conductor layer is formed via the resist. Examples of a method of forming a metal film include sputtering, plating, and vapor deposition, and plating is preferred.

Thus, the antenna device 100 that has the structure of the first conductor layer 1/the inorganic material substrate 2/the joint portion 6/the second conductor layer 4/the supporting substrate 3 and that includes the cavity portion 5 is manufactured.

The antenna device 100 described above can be applied to any appropriate optical device (e.g., a waveguide device and an electromagnetic wave sensor). In particular, the band of electromagnetic waves that can be used in the antenna device 100 is broadened, and hence the antenna device 100 can be suitably used for a human presence sensor, of which an excellent resolution is required. When the antenna device 100 described above is applied to a human presence sensor, a movement (gesture) of a person can be detected with high accuracy. Examples of the human presence sensor include an in-vehicle gesture detection sensor and a gesture detection sensor for a human-machine interface (HMI).

### EXAMPLES

The present disclosure is specifically described below by way of Examples. However, the present disclosure is not limited by these Examples.

### Example 1

A quartz glass wafer (inorganic material substrate) having a thickness of 0.5 mm was prepared. A 0.02 μm amorphous silicon film (first joint layer) was formed on the surface of the inorganic material substrate by sputtering. After the film formation, the first joint layer was polished to be planarized. Here, the arithmetic average roughness of a 010 μm on the surface of the first joint layer was measured using an atomic force microscope, and was found to be 0.2 nm.

In addition, a silicon wafer (supporting substrate) having a thickness of 250 μm was prepared. Then, the recess was formed in the upper surface of the supporting substrate by reactive ion etching. The recess had a substantially rectangular shape as viewed from the thickness direction of the supporting substrate. A dimension of the recess in its long-side direction was 1, 100 μm, a dimension of the recess in its short-side direction was 720 μm, and the depth of the recess was 175 μm.

Then, on the upper surface of the supporting substrate in which the recess was formed, a gold film (second conductor layer) having a thickness of 1 μm was formed by sputtering. The second conductor layer integrally included the ground conductor layer positioned in the recess and the first ground layer positioned on the part of the upper surface of the supporting substrate that excludes the recess.

Then, a 0.02 μm amorphous silicon film (second joint layer) was formed on the second conductor layer by sputtering. After the film formation, the second joint layer was polished to be planarized. Here, the arithmetic average roughness of a 010 μm on the surface of the second joint layer was measured using an atomic force microscope, and was found to be 0.2 nm.

Then, the inorganic material substrate and the supporting substrate were directly joined to each other as described below. First, the inorganic material substrate on which the first joint layer was formed and the supporting substrate on which the second joint layer and the second conductor layer were formed were loaded into a vacuum chamber, and in a vacuum of the order of 10⁻⁶ Pa, both joining surfaces (the surfaces of the first joint layer and the second joint layer) were irradiated with a high-speed Ar neutral atom beam (acceleration voltage: 1 kV, Ar flow rate: 60 sccm) for 70 seconds. After the irradiation, the inorganic material substrate and the supporting substrate were left to stan δ for 10 minutes to cool, and the surfaces of the first joint layer and the second joint layer (beam-irradiated surfaces) were brought into contact with each other, followed by pressurization at 4.90 kN for 2 minutes to join the inorganic material substrate and the supporting substrate to each other.

That is, the inorganic material substrate and the supporting substrate were directly joined to each other via the joint portion and the second conductor layer. After the joining, polishing processing was performed until the thickness of the inorganic material substrate became 50 μm.

Then, a resist was applied to the surface (polished surface) of the inorganic material substrate on the opposite side to the joint portion, and patterning was performed by photolithography so as to expose portions for forming the first conductor layer. After that, on the upper surface of the inorganic material substrate exposed from the resist, a copper film (first conductor layer) having a thickness of 5 μm was formed by sputtering. After that, the resist was removed.

The first conductor layer included the patch antenna and the MS-type signal wiring. The patch antenna had a substantially rectangular shape as viewed from the thickness direction of the inorganic material substrate. The length of the patch antenna (in the direction orthogonal to the direction of the line II-II′ of FIG. 1) was 860 μm, and the width of the patch antenna (in the direction of the line II-II′ of FIG. 1) was 590 μm. The MS-type signal wiring was formed of the wide portion and the narrow portion, and a line width of each of the portions was set so that the impedance was matched at 50Ω.

Thus, the antenna device illustrated in FIG. 1, that is, the antenna device having the configuration of the first conductor layer/the inorganic material substrate/the joint portion/the second conductor layer/the supporting substrate, was obtained. The antenna device included the cavity portion corresponding to the recess. When the patch antenna was projected in the thickness direction of the inorganic material substrate, the entire projection surface of the patch antenna overlapped with the cavity portion. The projected area of the patch antenna was 507, 400 μm², and the projected area of the cavity portion was 792,000 μm².

### Comparative Example 1

The antenna device was obtained in the same manner as in Example 1 except that the recess was not formed in the supporting substrate. The antenna device did not include the cavity portion.

### <Measurement of S11 Parameter>

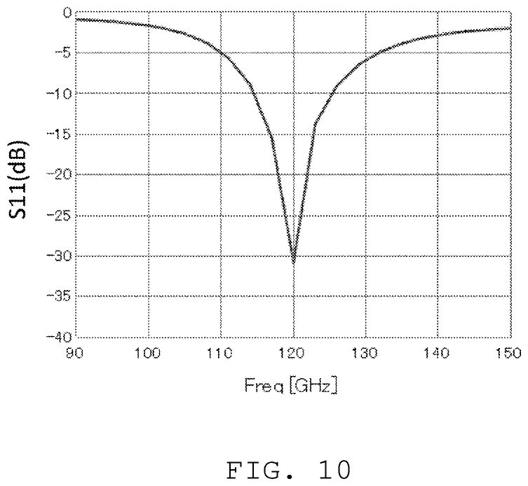

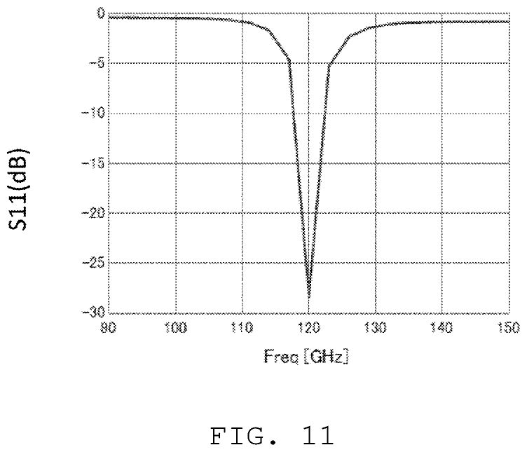

For each of the antenna devices obtained in Example and Comparative Example, the S11 parameter representing the return loss was measured through use of a network analyzer by setting a sampling frequency to 120 GHz. The results are shown in FIG. 10 and FIG. 11.

As apparent from FIG. 10, when the antenna device includes the cavity portion, the bandwidth of the electromagnetic wave in which the S11 parameter of the antenna device is −10 dB or less (−10 dB bandwidth) is 10.2 GHz. In contrast, as shown in FIG. 11, in the antenna device that does not include the cavity portion, the −10 dB bandwidth is 4.9 GHZ. Accordingly, it can be found that the band to be used in the antenna device can be broadened when the antenna device includes the cavity portion.

The antenna device according to the embodiments of the present disclosure can be used in a wide range of fields, such as next-generation high-speed communication and sensors, and in particular, can be suitably used as a human presence sensor.

What is claimed is:

1. An antenna device, comprising:
an inorganic material substrate;
a first conductor layer arranged on one side of the inorganic material substrate in a thickness direction of the inorganic material substrate, the first conductor layer including a patch antenna;
a supporting substrate arranged on an opposite side to the first conductor layer with respect to the inorganic material substrate;
a cavity portion arranged on the opposite side to the first conductor layer with respect to the inorganic material substrate and arranged on the inorganic material substrate side of the supporting substrate; and
a ground conductor layer arranged in the cavity portion, the ground conductor layer being capable of generating an electric field between the ground conductor layer and the patch antenna,
wherein a thickness “t” of the inorganic material substrate satisfies the below-indicated expression (1), and
wherein, when the patch antenna is projected in the thickness direction of the inorganic material substrate, at least a part of a projection surface of the patch antenna overlaps with the cavity portion:
$$t < \frac{λ}{a \sqrt{ε}} \qquad ( 1 )$$
where “t” represents the thickness of the inorganic material substrate, λ represents a wavelength of an electromagnetic wave transmitted and/or received by the antenna device, ε represents a relative dielectric constant of the inorganic material substrate, and “a” represents a numerical value of 3 or more.

2. The antenna device according to claim 1, wherein, when the patch antenna is projected in the thickness direction of the inorganic material substrate, the entire projection surface of the patch antenna overlaps with the cavity portion.

3. The antenna device according to claim 1, wherein the first conductor layer further includes a transmission line connected to the patch antenna.

4. The antenna device according to claim 3, further comprising a first ground layer arranged between the inorganic material substrate and the supporting substrate and in a part different from the cavity portion,
wherein, when the transmission line is projected in the thickness direction of the inorganic material substrate, at least a part of a projection surface of the transmission line overlaps with the first ground layer.

5. The antenna device according to claim 4, further comprising a joint portion configured to join the inorganic material substrate and the supporting substrate to each other.

6. The antenna device according to claim 5,
wherein the joint portion includes:
a first joint layer arranged on a surface of the inorganic material substrate on the opposite side to the first conductor layer in the thickness direction of the inorganic material substrate; and
a second joint layer arranged on a surface of the first ground layer on an opposite side to the supporting substrate in the thickness direction of the inorganic material substrate, and
wherein the second joint layer is joined to the first joint layer.

7. The antenna device according to claim 1, wherein the thickness “t” of the inorganic material substrate is 100 μm or less.

8. The antenna device according to claim 1, wherein a frequency of the electromagnetic wave transmitted and/or received by the antenna device is from 20 GHz to 20 THz.

9. The antenna device according to claim 1, wherein the inorganic material substrate is formed of quartz glass.

10. The antenna device according to claim 1, wherein the supporting substrate is formed of silicon.
